(19) United States
(12) Patent Application Publication
(10) Pub. No.: US 2010/0049990 A1
(43) Pub. Date: Feb. 25, 2010

(54) STORAGE DEVICE AND RECORDING AND REPRODUCING SYSTEM

(75) Inventors: Hiroshi Sukegawa, Tokyo (JP); Takashi Oshima, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/478,139

(22) Filed: Jun. 4, 2009

(30) Foreign Application Priority Data
Aug. 22, 2008 (JP) 2008-214223

(51) Int. Cl. G06F 12/14

(52) U.S. Cl. 713/193

(57) ABSTRACT

A storage device includes a decryption section, non-volatile memory, and an encryption section. The decryption section decrypts externally input encrypted data. The non-volatile memory records data decrypted by the decryption section. The encryption section encrypts and outputs decrypted data read out from the non-volatile memory.

### CROSS REFERENCE TO RELATED APPLICATION

This application is based upon and claims the benefit of priority from the prior Japanese Patent Application No. 2008-214223 filed in Japan on Aug. 22, 2008; the entire contents of which are incorporated herein by reference.

### BACKGROUND OF THE INVENTION

1. Field of the Invention

The present invention relates to a storage device and a recording and reproducing system using the same.

2. Description of the Related Art

As a conventional art for protecting data against errors, it has been proposed that, when user data is stored in a storage medium in an encrypted form, processing information specifying how to process the user data is added to a read or write command, and the user data is processed in accordance with the processing information so that the data is decrypted before being output or encrypted before being written to a storage medium (see Japanese Patent Application Laid-Open Publication No. 2005-505853, for instance).

A technique has also been proposed that increases degree of difficulty in illegally reconstructing compressed data when a decompression key is not available and enhances strength of data protection by adding a bit error to compressed data utilizing the fact that an error of several bits makes it impossible to decompress and reconstruct data at bit positions at which the error is occurring and subsequent data (see Japanese Patent Application Laid-Open Publication No. 2004-48256, for instance).

Furthermore, such a technique has been disclosed that encrypts data to be stored in a storage section using an encryption key and, when reading the encrypted data from the storage section, decrypts the data using the encryption key that was used for encryption and outputs the decrypted data. While the encrypted data can be correctly decrypted into data before encryption using the encryption key, if incorrect data is read from the storage section, data before encryption cannot be correctly reproduced using the encryption key and read out of invalid data is detected. And output of the invalid data is prohibited, thereby permitting output of only valid data (see Japanese Patent Application Laid-Open Publication No. 2006-135815, for instance).

However, when data encrypted for copyright protection, for example, is recorded in non-volatile memory and a one-bit error occurs in the recorded encrypted data, none of the techniques described in the patent documents can prevent the error from becoming a multi-bit error at the time of encryption or decryption to magnify the influence of the error.

### SUMMARY OF THE INVENTION

A storage device according to an aspect of the present invention includes a decryption section configured to decrypt externally input encrypted data; non-volatile memory configured to record data that has been decrypted by the decryption section; and an encryption section configured to encrypt and output decrypted data read out from the non-volatile memory.

A recording and reproducing system according to another embodiment of the present invention includes a storage device, including: a decryption section configured to decrypt externally input encrypted data; non-volatile memory configured to record data decrypted by the decryption section; and an encryption section configured to encrypt and output decrypted data read out from the non-volatile memory, and a host-side controller to which encrypted data output from the storage device is input and which decrypts the encrypted data and reproduces and outputs decrypted data, the host-side controller including means for notifying an encryption method used for input data to the storage device.

### BRIEF DESCRIPTION OF THE DRAWINGS

FIG. 1 is a configuration diagram showing a concept of processing of a recording and reproducing system according to an embodiment of the present invention where a one-bit error is occurring;

FIG. 2 is a configuration diagram showing a physical concept of a storage device of FIG. 1 where a decryption section and an encryption section are realized with MPU software;

FIG. 3 is a configuration diagram showing a physical concept of the storage device of FIG. 1 where the decryption section and the encryption section are realized with DSP hardware;

FIG. 4 illustrates a concept of processing for when no error is occurring in a configuration according to a technique relating to the present invention; and

FIG. 5 illustrates a concept of processing for when a one-bit error is occurring in a configuration according to a technique relating to the present invention.

### DETAILED DESCRIPTION OF THE PREFERRED EMBODIMENTS

Embodiments of the present invention will be described with reference to drawings.

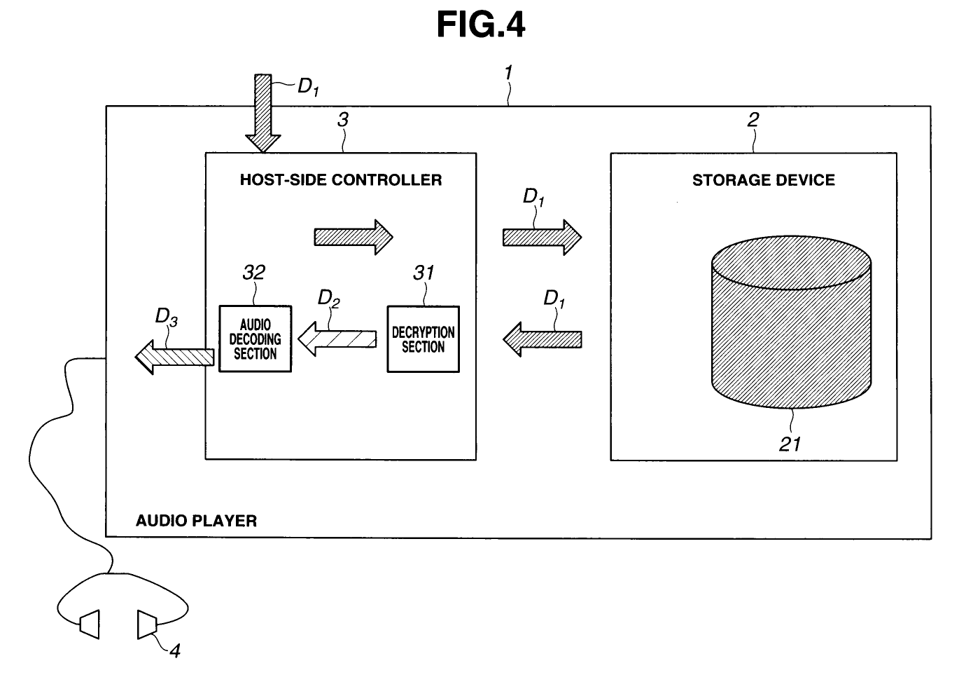

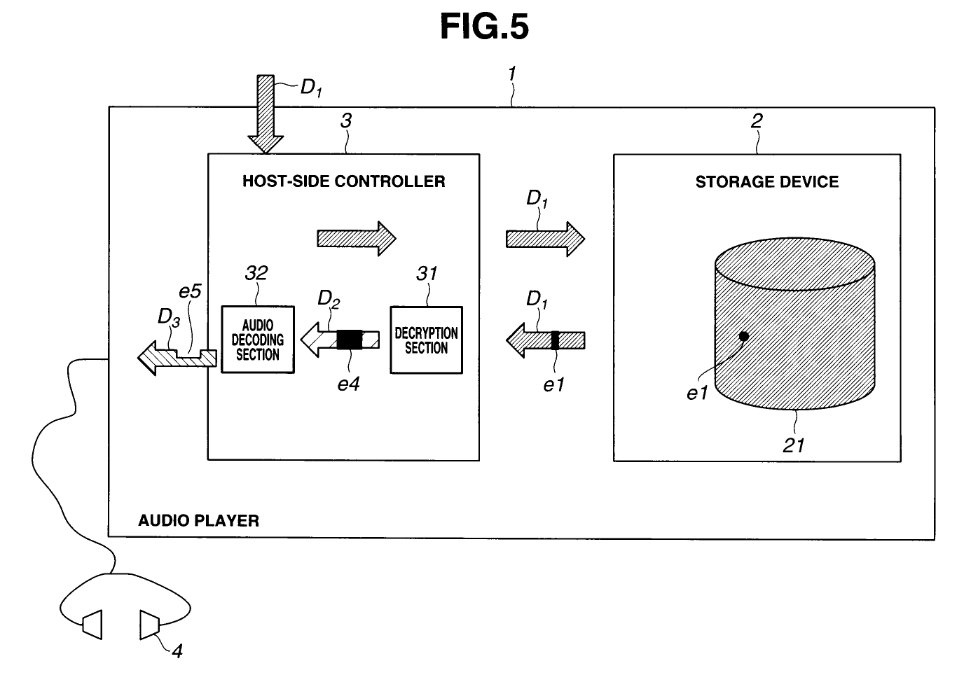

FIGS. 4 and 5 illustrate a recording and reproducing system (e.g., an audio player) according to a technique relating to the present invention. FIG. 4 shows a concept of processing for when there is no error, and FIG. 5 shows a concept of processing for when a one-bit error is occurring.

In these figures, reference numeral 1 denotes an audio player using a compression method called, for example, MP3 or AAC, as the compression method for music data. Music data supplied to the audio player 1 is data that is compressed and also encrypted for copyright protection.

The audio player 1 includes a storage device 2 containing non-volatile memory 21 (e.g., NAND-type flash memory) and a host-side controller 3 that includes a decryption section 31 and an audio decoding section 32. To the audio player 1, a head phone or an ear phone for listening to an audio signal, such as music, is connected.

When no error is occurring in the NAND-type flash memory 21, which is an example of non-volatile memory, encrypted data which is input externally, such as through downloading, is recorded in the NAND-type flash memory 21 in the storage device 2, read from the storage device 2 at the time of listening to be decrypted in the decryption section 31 in the host-side controller 3, and then compression codec is demodulated in the audio decoding section 32 to output the data as audio reproducing data, as shown in FIG. 4. Encryption is cleared by the decryption section 31 and compression is cleared in the audio decoding section 32.

When a one-bit error is occurring in the NAND-type flash memory 21, encrypted data D1 which is input externally, such as through downloading, is recorded in the NAND-type flash memory 21 in the storage device 2 and, if a one-bit error e1 has occurred, the data D1 is read from the storage device 2 with the error e1 at the time of listening, as shown in FIG. 5. In this condition, the encrypted data D1 output from the storage device 2 also contains a one-bit error, but when the encrypted data D1 is decrypted by the decryption section 31 of the host-side controller 3, the error expands by becoming a multi-bit error e4 (e.g., 16 bits), and a large reproduction error (denoted as reference numeral e5) will occur in audio reproducing data D3 when compression codec is demodulated by the audio decoding section 32. In the figure, reference numeral D2 denotes data already decrypted from the encrypted data D1.

Consequently, when a reproducing application reproduces a compressed multimedia file, such as music or images, in the audio decoding section 32, the error appears as a large error that exceeds correction ability, whereas a one-bit error would have less influence and could be corrected. This can cause degradation of the quality of reproduced content as the entire system handles the error as a large one although only a one-bit error is occurring in the storage device.

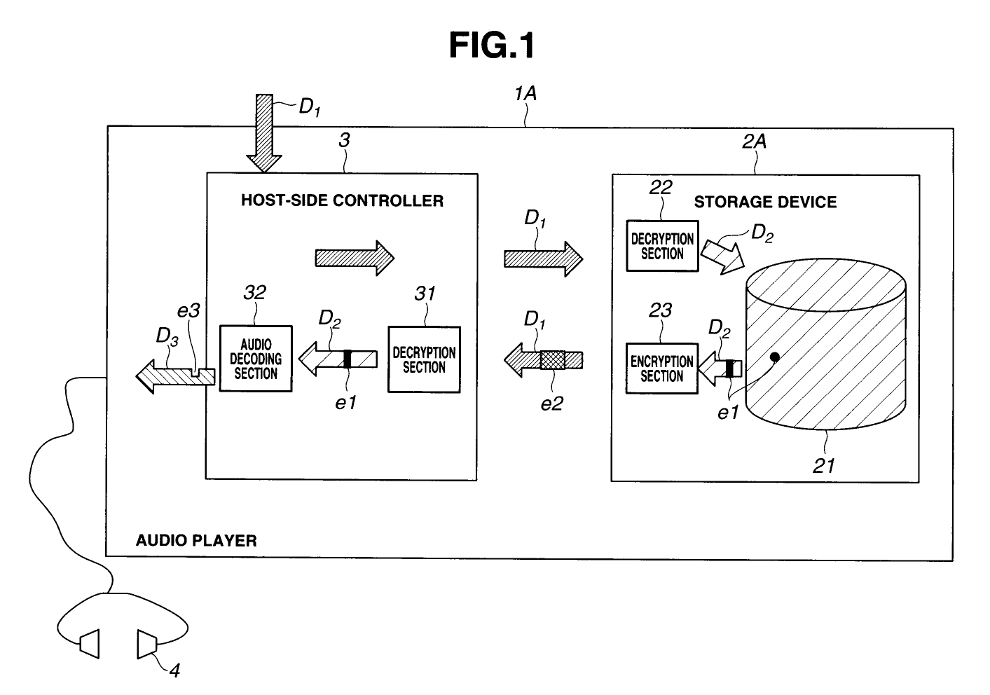

In an embodiment of the present invention discussed below, data that flows in an external interface of the storage device 2 is input as encrypted data, and the data is decrypted in the decryption section 22 (see FIG. 1) provided in the storage device 2 and is recorded in the NAND-type flash memory 21 as a recording device. The embodiment thereby provides a system in which a one-bit error occurring on the recording device is output from the storage device 2 at the time of readout through an encryption section 23 (see FIG. 1), which is newly provided, and undergoes decryption in the decryption section 31 in the host-side controller 3, and thereafter data appears still with a one-bit error. Thus, the embodiment of the present invention provides decryption functions which exist only in the host-side controller 3 which is a reproducing side in conventional arts, also within the storage device 2.

FIG. 1 is a configuration diagram showing a concept of processing of a recording and reproducing system according to an embodiment of the present invention. FIG. 1 shows a concept of processing for when a one-bit error is occurring. In FIG. 1, components having same functions as FIGS. 4 and 5 are given the same reference numerals.

In FIG. 1, an audio player 1A as the recording and reproducing system includes a storage device 2A and a host-side controller 3.

The storage device 2A includes the NAND-type flash memory 21 as an example of non-volatile memory as well as the decryption section 22 and the encryption section 23.

The decryption section 22 has functions of decrypting encrypted data D1 which has been input (i.e., clearing encryption of encrypted data to convert the data into plaintext) and outputting the data as decrypted data D2 to the NAND-type flash memory 21.

The encryption section 23 has functions of encrypting decrypted data D2 read from the NAND-type flash memory 21 and outputting the data as encrypted data D1 to the host-side controller 3.

The host-side controller 3 has a decryption section 31 and an audio decoding section 32, which serves as a reproducing section, as in FIGS. 4 and 5. The decryption section 31 has identical functions with the decryption section 22 described above. Encryption is cleared in the decryption section 31 and compression is cleared in the audio decoding section 32.

After encrypted data D1 is decrypted in the decryption section 31 in the host-side controller 3, compression codec is demodulated in the audio decoding section 32 and the data is output as audio reproducing data D3.

In FIG. 1, externally input encrypted data D1 is decrypted in the decryption section 22 in the storage device 2A into decrypted data D2, which is then recorded in the NAND-type flash memory 21 in the storage device 2A. Here, if a one-bit error e1 occurs in the NAND-type flash memory 21, the error e1 expands by becoming a multi-bit error e2 because the decrypted data D2 which is output from the storage device 2A at the time of data readout is encrypted in the encryption section 23. However, the error recovers to the one-bit error e1 because decryption is performed in the decryption section 31 of the host-side controller 3, and just a minor reproduction error (denoted by reference numeral e3) appears in the audio reproducing data D3.

According to the embodiment of the present invention, by configuring a storage device that records data that has been decrypted in the storage device 2A in a recording device and encrypts and outputs the data at the time of readout thereof, it is possible to realize a recording and reproducing system that does not cause expansion of an error when decryption is performed in the host-side controller 3, which is used at a later phase. Also, since the storage device 2A is manufactured as one chip or one package and decryption and encrypting operations take place inside the storage device 2A, there is no leakage of already decrypted data from the storage device 2A.

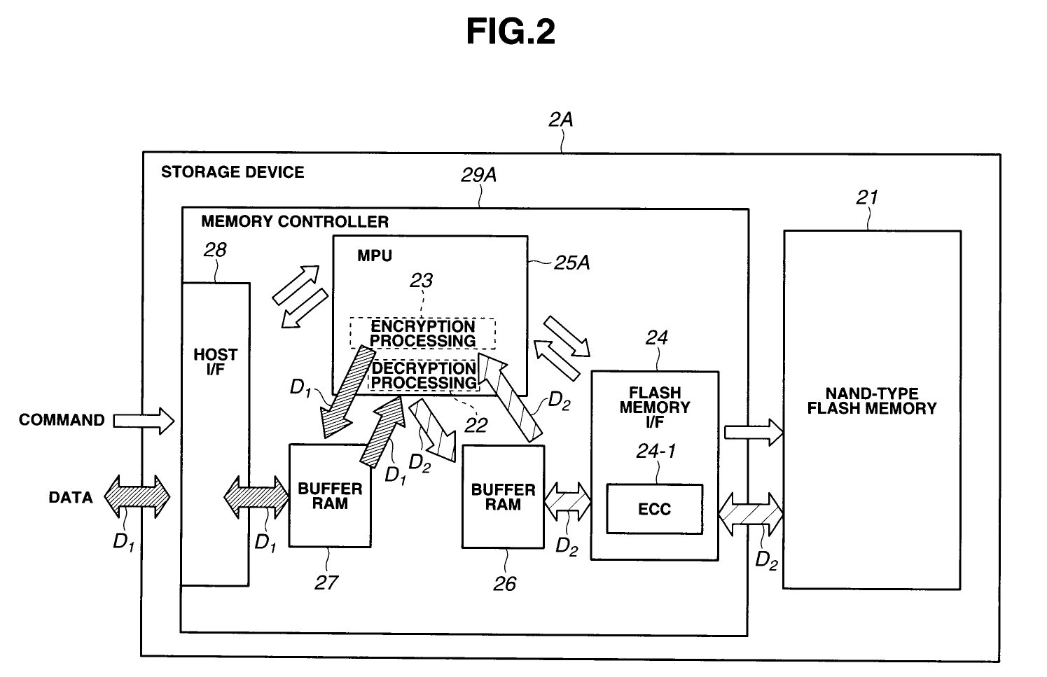

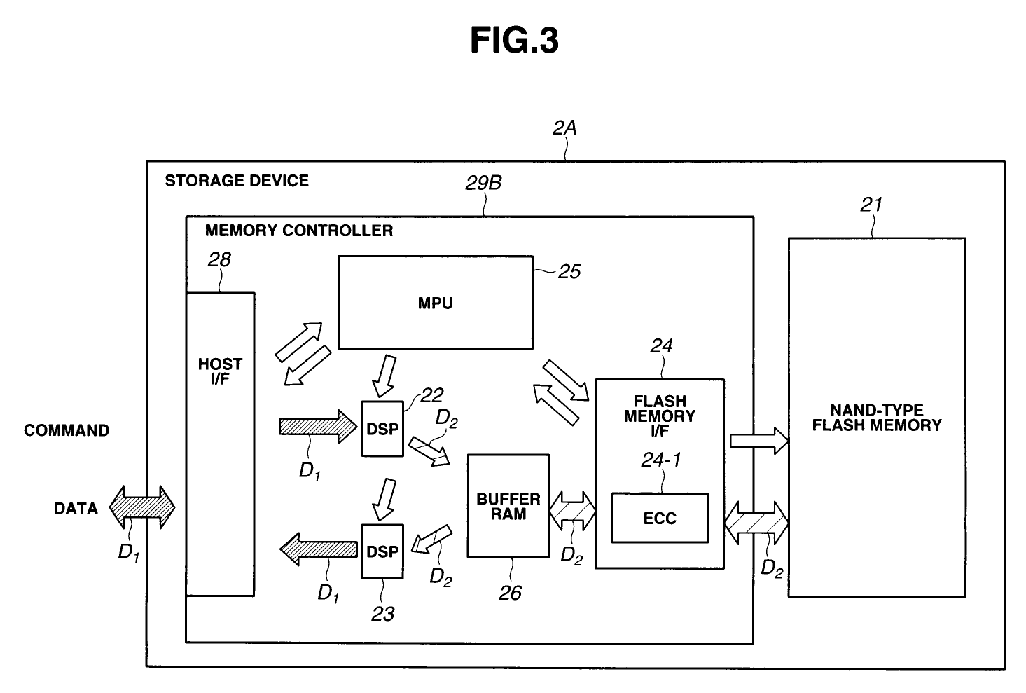

FIGS. 2 and 3 are configuration diagrams showing physical concepts of the storage device of FIG. 1. FIG. 2 shows a physical concept for when the decryption section and the encryption section of FIG. 1 are realized with MPU software, and FIG. 3 shows a physical concept of when the decryption section and the encryption section of FIG. 1 are realized with DSP hardware. In FIGS. 2 and 3, components having the same functions are given the same reference numerals.

In both of FIGS. 2 and 3, the storage device 2A is physically composed of the NAND-type flash memory 21 as an example of non-volatile memory and memory controller 29A or 29B for the memory 21.

The memory controller 29A shown in FIG. 2 has a flash memory interface (hereinafter “flash memory I/F”) 24 which includes an error correction circuit (hereinafter “ECC”) 24-1 and functions as an interface between the NAND-type flash memory 21 and the memory controller 29A, a microprocessor unit (hereinafter MPU) 25A which has a function of controlling the flash memory I/F 24 and a host I/F 28 discussed below and has decryption processing and encryption processing functions similar to those of the decryption section 22 and the encryption section 23 shown in FIG. 1, buffer RAM 26 provided between the flash memory I/F 24 and the MPU 25A for temporarily maintaining plaintext data D2 (i.e., decrypted data), a host interface (hereinafter host I/F) 28 which is provided at the memory controller 29A and functions as an interface between the host-side controller 3 and the memory controller 29A, and buffer RAM 27 provided between the MPU 25A and the host I/F 28 for temporarily maintaining encrypted data D1.

In the configuration of FIG. 2, the decryption processing function of the decryption section 22, encryption processing function of the encryption section 23 and the decryption section 31 in the host-side controller 3 shown in FIG. 1 have encryption or decryption processing functions based on a plurality of encryption methods. This enables one encryption method that can be used in common by the decryption section 22, encryption section, 23, and decryption section 31 to be selected (or switched to) for performing encryption and decryption even when data of any encryption method among various types of encrypted data (e.g., multiple encryption methods with different numbers of bits, multiple encryption methods of different versions originating from a particular encryption method, or multiple encryption methods by different developers) is input from the host-side controller 3 not shown. Therefore, when the audio player 1 is used, an encryption method that has been input to the host-side controller 3 is notified by the host-side controller 3 to the storage device 2 as a command or being included as part of data. By designing the recording and reproducing system to have means for the host-side controller 3 to notify an encryption method to the storage device 2, decryption and recording in the storage device 2 is possible for encrypted data of different types.

Furthermore, by designing the storage device to have an encryption method that can be programmed with MPU software, an encryption method that was not established at the time of design or manufacturing of the storage device can be handled. Also, even an encryption method that was already known at the time of design or manufacturing of the storage device can be made to support many other encryption methods without involving increase in hardware cost.

The memory controller 29B shown in FIG. 3 has a flash memory I/F 24 that includes an ECC 24-1 and functions as an interface between the NAND-type flash memory 21 and the memory controller 29B, a digital signal processor (hereinafter DSP) as the decryption section 22, a DSP as the encryption section 23, buffer RAM 26 provided between the flash memory I/F 24 and the DSPs 22 and 23 for temporarily maintaining plaintext data D2 (i.e., decrypted data), a host I/F 28 which is provided in the memory controller 29B and functions as an interface between the host-side controller 3 and the memory controller 29B, and a MPU 25 which has functions of controlling the flash memory I/F 24, host I/F 28, and DSPs 22 and 23.

In the configuration of FIG. 3, the DSP as the decryption section 22, the DSP as the encryption section 23, and the decryption section 31 in the host-side controller 3 shown in FIG. 1 have encryption or decryption processing functions based on a plurality of encryption methods. This enables one encryption method that can be used in common by the decryption section 22, encryption section 23, and decryption section 31 to be selected (or switched to) for performing encryption and decryption even when data of any encryption method among various types of encrypted data (e.g., multiple encryption methods with different numbers of bits, multiple encryption methods of different versions originating from a particular encryption method, or multiple encryption methods by different developers) is input from the host-side controller 3 not shown. Therefore, when the audio player 1 is used, an encryption method that has been input to the host-side controller 3 is notified by the host-side controller 3 to the storage device 2 as a command or being included as part of data. By designing the recording and reproducing system to have means for the host-side controller 3 to notify an encryption method to the storage device 2, decryption and recording in the storage device 2 is possible for encrypted data of different types.

Furthermore, by designing the storage device to have an encryption method that can be programmed with a DSP, an encryption method that was not established at the time of design or manufacturing of the storage device can be handled. Also, even an encryption method that was already known at the time of design or manufacturing of the storage device can be made to support many other encryption methods without involving increase in hardware cost.

According to the present invention described above, it is possible to realize a storage device and a recording and reproducing system that can prevent a one-bit error from becoming a multi-bit error at the time of encryption or decryption to magnify the influence of the error even when a one-bit error has occurred in encrypted data.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A storage device, comprising:
a decryption section configured to decrypt externally input encrypted data;
non-volatile memory configured to record data that has been decrypted by the decryption section; and
an encryption section configured to encrypt and output decrypted data read out from the non-volatile memory.

2. The storage device according to claim 1, wherein
the decryption section and the encryption section are configured to work based on a plurality of encryption methods.

3. The storage device according to claim 1, wherein
the decryption section and the encryption section are configured to select a programmable encryption method.

4. The storage device according to claim 1, wherein
the decryption section and the encryption section are provided as a software in a MPU.

5. The storage device according to claim 1, wherein
the decryption section and the encryption section are provided as a hardware in a DSP.

6. The storage device according to claim 1, wherein
the decryption section, the non-volatile memory, and the encryption section are configured in one chip or one package.

7. The storage device according to claim 1, wherein
the externally input encrypted data is data encrypted for copyright protection.

8. A recording and reproducing system, comprising:
a storage device comprising a decryption section configured to decrypt externally input encrypted data, non-volatile memory configured to record data decrypted by the decryption section, and an encryption section configured to encrypt and output decrypted data read out from the non-volatile memory; and
a host-side controller to which encrypted data output from the storage device is input and which decrypts the encrypted data and reproduces and outputs decrypted data, the host-side controller comprising a portion configured to notify an encryption method used for input data to the storage device.

9. The recording and reproducing system according to claim 8, wherein
the host-side controller comprises a decryption section to which encrypted data from the encryption section of the storage device is input and which decrypts the encrypted data, and a reproducing section configured to demodulate the decrypted data and output reproduction data, and
the decryption section and the encryption section of the storage device, and the decryption section of the host-side controller are selected or switched to a single encryption method that can be used in common to perform encryption and decryption.

10. The recording and reproducing system according to claim 9, wherein
the single encryption method that can be used in common is selected or switched to from various encryption methods including a plurality of encryption methods with different numbers of bits, a plurality of encryption methods of different versions originating from a particular encryption method, and a plurality of encryption methods by different developers.
